(19) United States
(12) Patent Application Publication
(10) Pub. No.: US 2021/0200000 A1
(43) Pub. Date: Jul. 1, 2021

(54) COLLAGE DISPLAY PANEL

(71) Applicant: TCL China Star Optoelectronics Technology Co., Ltd., Shenzhen (CN)

(72) Inventor: Renlu CHEN, Shenzhen (CN)

(73) Assignee: TCL China Star Optoelectronics Technology Co., Ltd., Shenzhen (CN)

(21) Appl. No.: 16/623,795

(22) PCT Filed: Nov. 13, 2019
(86) PCT No.: PCT/CN2019/117781

§ 371 Date: Dec. 18, 2019

(30) Foreign Application Priority Data
Sep. 10, 2019 (CN) 201910851963.5

(51) Int. Cl. G02F 1/13; G02F 1/1335; G02F 1/1333

(52) U.S. Cl. CPC G02F 1/1309; G02F 1/13336; G02F 1/133512; G02F 1/133514

(57) ABSTRACT

The disclosure provides a collage display panel, including a first display panel and a second display panel which are spliced to each other. A side of a bonding region of the collage display panel is provided with a first alignment mark which is used as a standard line for detecting printing accuracy of a first metal line, thereby improving production yield, reducing risks, and preventing a problem of low image quality. Furthermore, both sides of the bonding region may be provided with an alignment mark, which can more concisely detect printing accuracy of the first metal line.

### FIELD

The present disclosure relates to the field of display technology and, more particularly, relates to a collage display panel.

### BACKGROUND

With improvements in side bonding technology and performance of thin film transistors (TFTs), extremely narrow border (ENB) splicing technology has been commonly used in public information displays (PIDs). The ENB splicing technology has many advantages, such as cost reduction of panel factories, satisfaction of client's requirements, and realization of super large splicing design without borders.

Regarding technical problem: The ENB splicing technology is also widely used in public display products. With demands for sizes and splicing flexibility of outdoor boards greatly increased, the ENB splicing technology uses forward-looking side bonding technology, while printing accuracy of silver lines at lateral sides of a panel is closely related to production yield of side bonding technology.

### SUMMARY

Consequently, it is necessary to provide a novel collage display panel, which can detect printing accuracy of silver lines, to solve the technical problem of low production yield of conventional side bonding technology.

An objective of the present disclosure is to provide a collage display panel. A side of a bonding region of the collage display panel is provided with a first alignment mark which is used as a standard line and can detect printing accuracy of a first metal line, thereby improving production yield.

The present disclosure provides a collage display panel, including a first display panel and a second display panel connected to each other and having a same structure, wherein both the first display panel and the second display panel include a display region and a fan-out region disposed at a side of the display region. The fan-out region of the first display panel is disposed correspondingly to the fan-out region of the second display panel, and a lateral wall of the first display panel includes a first metal line. Both the fan-out region of the first display panel and the fan-out region of the second display panel include a bonding region, and a side of the bonding region is provided with a first alignment mark.

Furthermore, the first display panel includes an array substrate, a color filter, and a liquid crystal layer disposed between the array substrate and the color filter.

Furthermore, materials of the first alignment mark include copper or resin.

Furthermore, a shape of the first alignment mark includes a line or a crisscross shape.

Furthermore, the first alignment mark is disposed on the array substrate.

Furthermore, the first alignment mark is disposed in the color filter and is disposed on a same layer with a black matrix of the color filter.

Furthermore, a material of the first metal line includes silver.

Furthermore, the other side of the bonding region is provided with a second alignment mark, and the second alignment mark and the first alignment mark have a same shape and a same size.

Furthermore, the first metal line is correspondingly offset from the first alignment mark by a distance ranging from 10 μm to 50 μm.

Furthermore, the first metal line is disposed between the first alignment mark and the second alignment mark.

Regarding the beneficial effects: the present disclosure provides a collage display panel. A side of a bonding region of the collage display panel is provided with a first alignment mark which is used as a standard line for detecting printing accuracy of a first metal line, thereby improving production yield, reducing risks, and preventing a problem of low image quality. Furthermore, both sides of the bonding region may be provided with an alignment mark, which can more concisely detect printing accuracy of the first metal line.

### DESCRIPTION OF DRAWINGS

The accompanying figures to be used in the description of embodiments of the present disclosure or prior art will be described in brief to more clearly illustrate the technical solutions of the embodiments or the prior art. The accompanying figures described below are only part of the embodiments of the present disclosure, from which those skilled in the art can derive further figures without making any inventive efforts.

FIG. 1 is a top view showing a collage display panel provided by the present disclosure.

FIG. 2 is a schematic view showing a sectional structure of a display panel provided by the present disclosure.

### DETAILED DESCRIPTION

The following description of the various embodiments is provided with reference to the accompanying drawings. It should be understood that terms such as “upper”, “lower”, “front”, “rear”, “left”, “right”, “inside”, “outside”, “lateral”, as well as derivative thereof should be construed to refer to the orientation as then described or as shown in the drawings under discussion. Thus, features limited by “first” and “second” are intended to indicate or imply including one or more than one these features. In the drawings, the identical or similar reference numerals constantly denote the identical or similar elements or elements having the identical or similar functions.

Examples of the described embodiments are given in the accompanying drawings, and the specific embodiments described with reference to the accompanying drawings are all exemplary and are intended to interpret the practical application of the present disclosure, which shall not be construed as causing limitations to the present disclosure. Therefore, those skilled in the art can understand the described embodiments and modifications to the described embodiments.

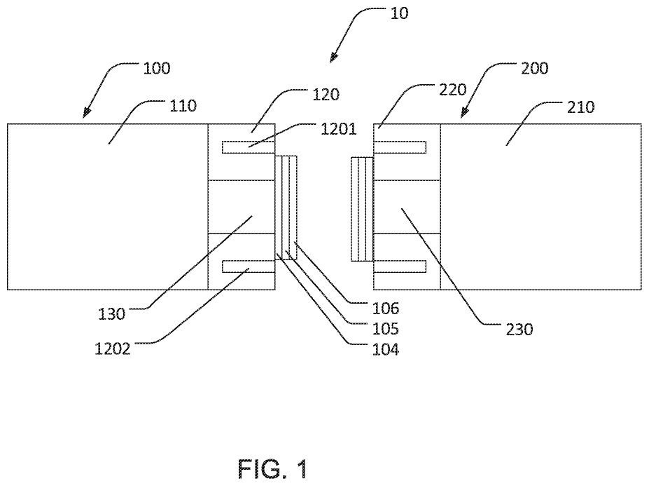

As shown in FIG. 1, the present disclosure provides a collage display panel 10, including a first display panel 100 and a second display panel 200 which are spliced to each other.

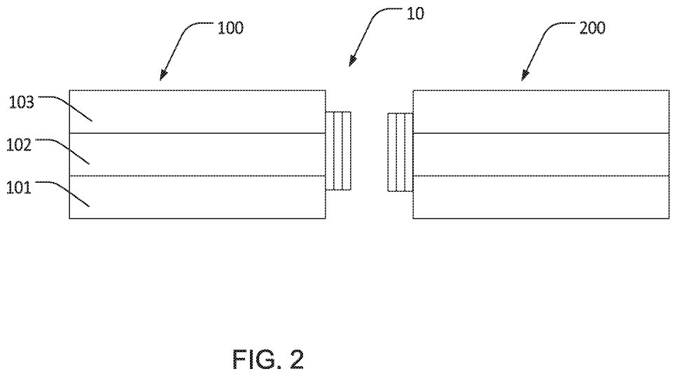

As shown in FIG. 2, the first display panel 100 includes an array substrate 101, a color filter 103, and a liquid crystal layer 102 disposed between the array substrate 101 and the color filter 103. The first display panel 100 and the second display panel 200 have a same structure.

A splicing gap with a width ranging from 0.8 mm to 1.8 mm may exist between the first display panel 100 and the second display panel 200, and it is preferred that the width of the splicing gap is as small as possible.

Referring again to FIG. 1, the first display panel 100 includes a display region 110 and a fan-out region 120 disposed at a side of the display region 110. The second display panel 200 also includes a display region 210 and a fan-out region 220 disposed at a side of the display region 210. The fan-out region 120 of the first display panel 100 and the fan-out region 220 of the second display panel are disposed correspondingly to each other.

The first display panel 100 and the second display panel 200 have the same structure. A structure of the display panel 10 is described in detail below by taking the first display panel 100 as an example.

The fan-out region 120 includes a bonding region 130, and a side of the bonding region 130 is provided with a first alignment mark 1201. A shape of the first alignment mark 1201 includes a line or a crisscross shape. A preferred shape is a line, and a number of the first alignment mark 1201 is not limited by the present disclosure, that is, the first alignment mark 1201 may be a plurality of metal marking lines.

A lateral wall of the first display panel 100 is provided with a first metal line 104 connected to the bonding region 130. A material of the first metal line 104 includes silver. A copper line 105 and a chip on film (COF) 106 are sequentially disposed on the first metal line 104.

The first display panel 100 is connected to the second display panel 200 by a metal wire. The metal wire is respectively connected to the bonding region 130 of the first display panel 100 and a bonding region 230 of the display panel 200.

In one embodiment, the first alignment mark 1201 is disposed on the array substrate 101. A material of the first alignment mark 1201 is copper. The alignment mark 1201 may be manufactured in a first metal layer or a second metal layer of the array substrate 101.

In other embodiments, the first alignment mark 1201 is disposed in the color filter 103 and is disposed on a same layer with a black matrix of the color filter 103. Materials of the first alignment mark 1201 and the black matrix are resin.

The first metal line 104 is correspondingly offset from the first alignment mark 1201 by a distance ranging from 10 μm to 50 μm. The first alignment mark 1201 is used as a standard line for manufacturing the first metal line 104 and can detect printing accuracy of the first metal line 104, thereby improving production yield, reducing risks, and preventing a problem of low image quality.

The other side of the bonding region 130 is provided with a second alignment mark 1202 which has a same shape and a same size as the first alignment mark 1201.

The first metal line 104 is disposed between the first alignment mark 1201 and the second alignment mark 1202.

The present disclosure provides a collage display panel 10. A side of a bonding region 130 of the collage display panel 10 is provided with a first alignment mark 1201 which is used as a standard line for manufacturing a first metal line 104 and can detect printing accuracy of the first metal line 104, thereby improving production yield, reducing risks, and preventing a problem of low image quality. Furthermore, both sides of the bonding region 130 may be provided with an alignment mark, which can more concisely detect printing accuracy of the first metal line 104.

The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A collage display panel, comprising a first display panel and a second display panel spliced to each other and having a same structure, wherein both the first display panel and the second display panel comprise a display region and a fan-out region disposed at a side of the display region, the fan-out region of the first display panel is disposed correspondingly to the fan-out region of the second display panel, and a lateral wall of the first display panel comprises a first metal line;
wherein both the fan-out region of the first display panel and the fan-out region of the second display panel comprise a bonding region, and a side of the bonding region is provided with a first alignment mark.

2. The collage display panel of claim 1, wherein the first display panel comprises an array substrate, a color filter, and a liquid crystal layer disposed between the array substrate and the color filter.

3. The collage display panel of claim 1, wherein a material of the first alignment mark comprises copper or resin.

4. The collage display panel of claim 1, wherein a shape of the first alignment mark comprises a line or a crisscross shape.

5. The collage display panel of claim 2, wherein the first alignment mark is disposed on the array substrate.

6. The collage display panel of claim 2, wherein the first alignment mark is disposed in the color filter and is disposed on a same layer with a black matrix of the color filter.

7. The collage display panel of claim 1, wherein a material of the first metal line comprises silver.

8. The collage display panel of claim 1, wherein the other side of the bonding region is provided with a second alignment mark, and the second alignment mark and the first alignment mark have a same shape and a same size.

9. The collage display panel of claim 1, wherein the first metal line is correspondingly offset from the first alignment mark by a distance ranging from 10 μm to 50 μm.

10. The collage display panel of claim 8, wherein the first metal line is disposed between the first alignment mark and the second alignment mark.
